(19) United States
(12) Patent Application Publication
(10) Pub. No.: US 2022/0256890 A1
(43) Pub. Date: Aug. 18, 2022

(54) ANIMAL FEED SUPPLEMENT AND ANIMAL FEED COMPOSITION

(71) Applicant: MOOTRAL INNOVATIONS LIMITED, GWENT (GB)

(72) Inventors: Thomas Christian Hafner, Rolle (CH); Oliver RIEDE, Rolle (CH)

(73) Assignee: MOOTRAL INNOVATIONS LIMITED, GWENT (GB)

(21) Appl. No.: 17/625,284

(22) PCT Filed: Jul. 10, 2019
(86) PCT No.: PCT/EP2020/069518

§ 371 Date: Jan. 6, 2022

(30) Foreign Application Priority Data
Jul. 10, 2019 (EP) 19185425.6

(51) Int. Cl. A23K 20/158; A23K 20/105; A23K 20/111; A23K 50/10

(52) U.S. Cl. CPC A23K 20/158; A23K 50/10; A23K 20/111; A23K 20/105

(57) ABSTRACT

An animal feed supplement and an animal feed composition comprising said animal feed supplement and methods of making said animal feed supplement and animal feed composition.

### TECHNICAL FIELD

The present invention relates generally to an animal feed supplement comprising at least one organosulfur compound and at least one essential oil and/or at least one component of an essential oil. The present invention further relates to an animal feed composition comprising said animal feed supplement. The present invention also relates to the various uses of said animal feed supplement and said animal feed composition, and to methods of making said animal feed supplement and said animal feed composition.

### BACKGROUND

Livestock emissions are responsible for about 15% of all global greenhouse gas emissions and are the third largest contributor of greenhouse gases after energy and industry. Despite having a shorter lifetime, methane is a more potent greenhouse gas than carbon dioxide. Over a period of 20 years, the global warming effect of methane is around 84 times that of carbon dioxide. The global warming potential of methane is also attributed to its contribution to the formation of tropospheric ozone which warms the atmosphere. On average, a cow releases between 85 and 170 kg of methane per year.

Particular types of microbes in the gut of ruminant animals use the end products of the fermentation of nutrients consumed by the animal to produce methane as a by-product. In addition to the negative effects of methane on climate change, this also reduces the nutrients available for use by the animal.

It is therefore desirable to provide alternative and/or improved compositions to reduce methane production and/or increase availability of nutrients to an animal.

### SUMMARY

In accordance with a first aspect of the present invention there is provided an animal feed supplement comprising at least one organosulfur compound and at least one essential oil and/or at least one component of an essential oil. In certain embodiments, the animal feed supplement may consist essentially of or consist of organosulfur compound(s) and essential oil(s) and/or essential oil component(s).

In accordance with a second aspect of the present invention there is provided an animal feed composition comprising an animal feed supplement according to any aspect or embodiment of the present invention.

In accordance with a third aspect of the present invention there is provided a use of an animal feed supplement or animal feed composition according to any aspect or embodiment of the present invention to reduce methane production by an animal. As such, there is also provided a method for reducing methane production by an animal, the method comprising administering an animal feed supplement or animal feed composition according to any aspect or embodiment of the present invention to the animal. In certain embodiments, the animal is a ruminant animal or a pseudo-ruminant animal.

In accordance with a fourth aspect of the present invention there is provided a use of an animal feed supplement or animal feed composition according to any aspect or embodiment of the present invention to increase and/or increase efficiency of milk and/or meat and/or wool production by an animal. As such, there is also provided a method for increasing and/or increasing efficiency of milk and/or meat and/or wool production by an animal, the method comprising administering an animal feed supplement or an animal feed composition according to any aspect or embodiment of the present invention to the animal. In certain embodiments, the animal is a ruminant animal or a pseudo-ruminant animal.

In accordance with a fifth aspect of the present invention there is provided a use of an animal feed supplement or animal feed composition according to any aspect or embodiment of the present invention to increase availability of nutrients to an animal. As such, there is also provided a method for increasing availability of nutrients to an animal, the method comprising administering an animal feed supplement or an animal feed composition according to any aspect or embodiment of the present invention to the animal. In certain embodiments, the animal is a ruminant animal or a pseudo-ruminant animal.

In accordance with a sixth aspect of the present invention there is provided a method for making an animal feed supplement according to any aspect or embodiment of the present invention, the method comprising combining at least one organosulfur compound and at least one essential oil and/or at least one component of an essential oil.

In accordance with a seventh aspect of the present invention there is provided a method for making an animal feed composition according to any aspect or embodiment of the present invention, the method comprising combining an animal feed with at least one organosulfur compound and at least one essential oil and/or at least one component of an essential oil.

The uses and methods described herein are considered to be purely non-therapeutic.

However, to the extent that any of the uses and methods described herein are considered to be therapeutic, the therapeutic uses and methods and animal feed supplements and animal feed compositions for use in said therapeutic uses and methods are also provided as further aspects of the present invention.

In certain embodiments of any aspect of the present invention at least one organosulfur compound in the animal feed supplement is allicin.

In certain embodiments of any aspect of the present invention at least one organosulfur compound in the animal feed supplement is from a plant of the Allium genus, for example from Allium sativum (garlic). For example, at least one organosulfur compound may be from a garlic extract.

In certain embodiments of any aspect of the present invention at least one essential oil is selected from coriander oil, nutmeg oil, wild carrot oil, pine oil, clove oil, and combinations of two or more thereof.

In certain embodiments of any aspect of the present invention at least one component of an essential oil is selected from at least one component of coriander oil, at least one component of nutmeg oil, at least one component of wild carrot oil, at least one component of pine oil, at least one component of clove oil, and combinations of two or more components of one or more of coriander oil, nutmeg oil, wild carrot oil, pine oil, and clove oil.

In certain embodiments of any aspect of the present invention at least one essential oil is coriander oil.

In certain embodiments of any aspect of the present invention at least one component of an essential oil is at least one component of coriander oil.

In certain embodiments of any aspect of the present invention at least one component of an essential oil is selected from bornyl acetate, geranyl acetate, eugenol, linalool, geraniol, and neryl acetate. In certain embodiments of any aspect of the present invention at least one component of an essential oil is selected from bornyl acetate, geranyl acetate, and eugenol.

In certain embodiments of any aspect of the present invention the animal feed supplement further comprises at least one bioflavonoid. In certain embodiments, the animal feed supplement consists essentially of or consists of organosulfur compound(s), essential oil(s) and/or essential oil component(s), and bioflavonoid(s).

Embodiments of the invention will be further described in the detailed description. Any embodiment described herein or any combination of embodiments described herein is applicable to any one or more aspect of the present invention unless clearly contradicted by context.

### DETAILED DESCRIPTION OF THE FIGURES

The invention may be described with reference to the following figures demonstrating the results of the examples below, in which:

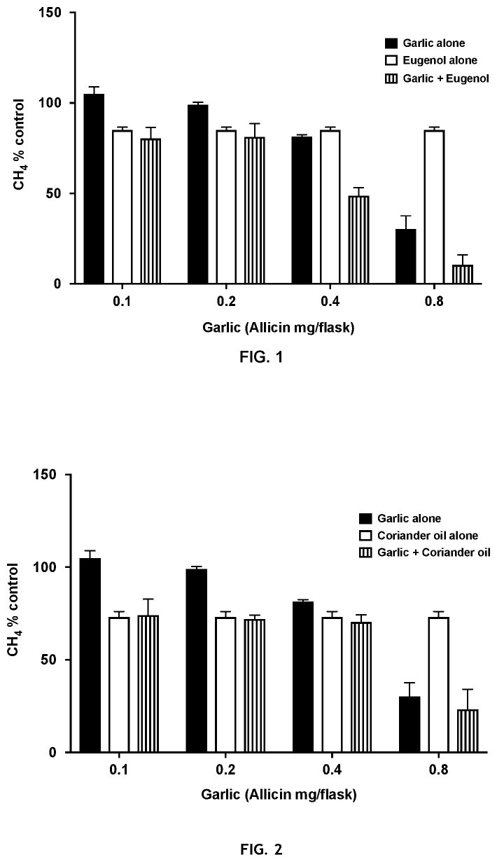

FIG. 1 shows the effect of the combination of garlic and eugenol compared to garlic and eugenol alone on the production of methane where allicin is used in an amount of 0.1, 0.2, 0.4, and 0.8 mg/flask;

FIG. 2 shows the effect of the combination of garlic and coriander oil compared to garlic and coriander oil alone on the production of methane where allicin is used in an amount of 0.1, 0.2, 0.4, and 0.8 mg/flask;

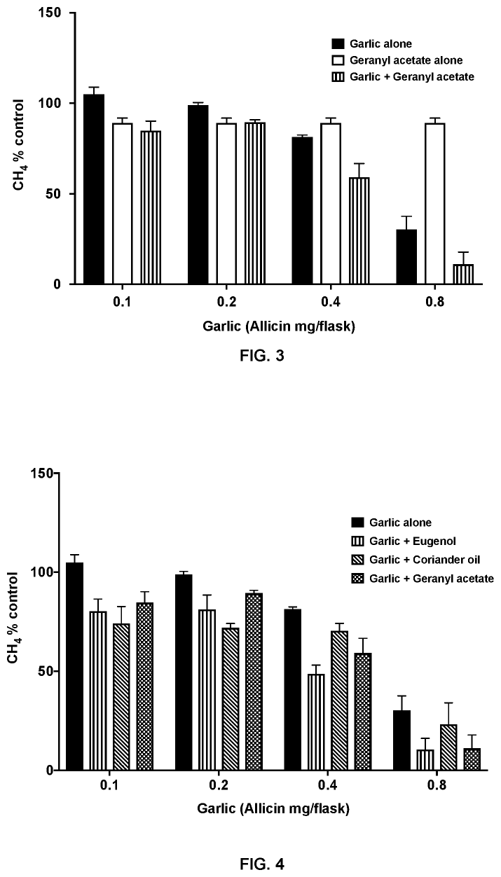

FIG. 3 shows the effect of the combination of garlic and geranyl acetate compared to garlic and geranyl acetate alone on the production of methane where allicin is used in an amount of 0.1, 0.2, 0.4, and 0.8 mg/flask;

FIG. 4 shows the effect of the combination of garlic with eugenol, coriander oil, or geranyl acetate compared to garlic alone on the production of methane where allicin is used in an amount of 0.1, 0.2, 0.4, and 0.8 mg/flask;

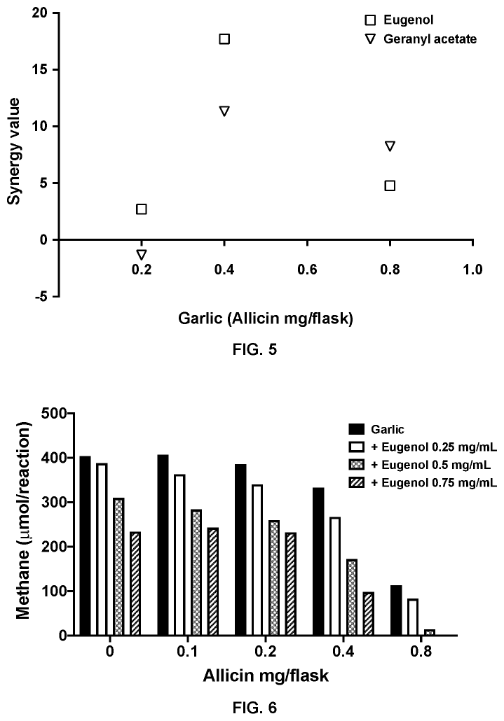

FIG. 5 shows the synergy value of garlic with eugenol or geranyl acetate where allicin is used in an amount of 0.2, 0.4, or 0.8 mg/flask;

FIG. 6 shows the effect of the combination of garlic and eugenol compared to garlic and eugenol alone on the production of methane where allicin is used in an amount of 0.1, 0.2, 0.4, and 0.8 mg/flask and eugenol used in an amount of 0.25, 0.5 and 0.75 mg/ml;

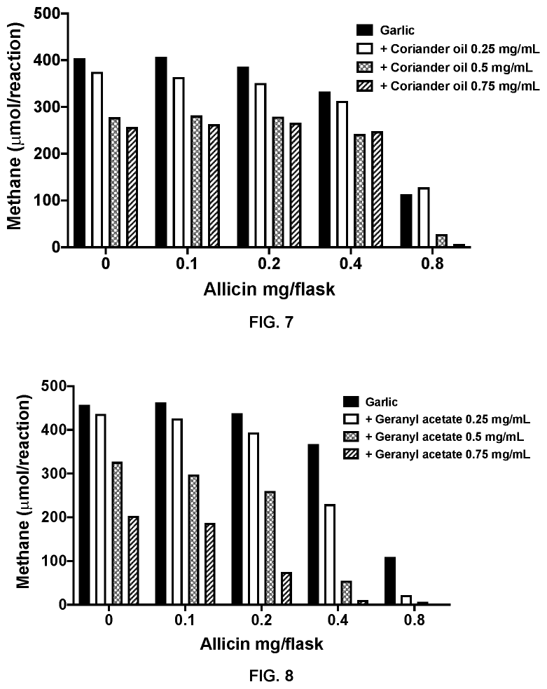

FIG. 7 shows the effect of the combination of garlic and geranyl acetate compared to garlic and geranyl acetate alone on the production of methane where allicin is used in an amount of 0.1, 0.2, 0.4, and 0.8 mg/flask and geranyl acetate used in an amount of 0.25, 0.5 and 0.75 mg/ml;

FIG. 8 shows the effect of the combination of garlic and coriander oil compared to garlic and coriander oil alone on the production of methane where allicin is used in an amount of 0.1, 0.2, 0.4, and 0.8 mg/flask and coriander oil used in an amount of 0.25, 0.5 and 0.75 mg/ml;

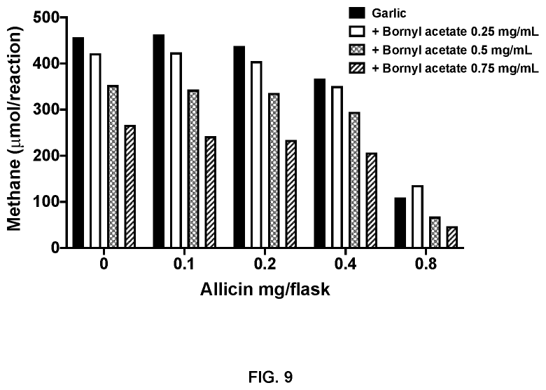

FIG. 9 shows the effect of the combination of garlic and bornyl acetate compared to garlic and bornyl acetate alone on the production of methane where allicin is used in an amount of 0.1, 0.2, 0.4, and 0.8 mg/flask and bornyl acetate used in an amount of 0.25, 0.5 and 0.75 mg/ml.

### DETAILED DESCRIPTION

The present invention is based, at least one part, on the surprising finding that a combination of at least one organosulfur compound with at least one essential oil and/or at least one component of an essential oil can reduce methane production and/or emissions by animals such as ruminant animals and pseudo-ruminant animals.

Hereinafter, the invention shall be described according to preferred embodiments of the present invention and by referring to the accompanying description. However, it is to be understood that limiting the description to the preferred embodiments of the invention is merely to facilitate discussion of the present invention and it is envisioned that those skilled in the art may devise various modifications without departing from the scope of the appended claims.

Where the term “at least one” or “one or more” occurs hereinbefore and hereinafter, this signifies in particular one to twenty or one to ten, for preference one to five or one to three, and in particular one or, further, two of the features enumerated, such as components. Where ranges are indicated, such as weight percentage ranges, these include the limit values indicated; thus, for example, “between X and Y” signifies “from and including X up to and including Y”.

The term “therapeutic treatment” or “therapeutic method”, also includes prophylaxis and the alleviation of symptoms of a disease and/or disorder in a subject, although not cosmetic treatments. The expression “treating or preventing” and analogous terms used herein refers to all forms of healthcare intended to remove or avoid the disease and/or disorder or to relieve its symptoms, including preventive and curative care, as judged according to any of the tests available according to the prevailing medical practice. An intervention that aims with reasonable expectation to achieve a particular result but does not always do so is included within the expression “treating or preventing”. An intervention that succeeds in slowing or halting progression of a disease and/or disorder is included within the expression “treating or preventing”.

The term “consisting of” excludes any additional element, step or ingredient not explicitly recited.

The term “consisting essentially of” excludes any additional element, step or ingredient not explicitly recited unless the additional element, step or ingredient does not materially affect the basic and novel properties of the invention. Where the one or more additional element(s), step(s) or ingredient(s) is/are one or more additional component(s) of a product or composition, the total amount of the additional component(s) in the composition may, for example, be limited to 20 wt %. For example, the total amount of the additional component(s) in the composition may be limited to 19 wt % or 18 wt % or 17 wt % or 16 wt % or 15 wt % or 14 wt % or 13 wt % or 12 wt % or 11 wt % or 10 wt % or 9 wt % or 8 wt % or 7 wt % or 6 wt % or 5 wt % or 4 wt % or 3 wt % or 2 wt % or 1 wt %.

Animal Feed Supplement

There is provided herein an animal feed supplement comprising at least one organosulfur compound and at least one essential oil and/or at least one component of an essential oil. The term “supplement” refers to a product or composition, which may, for example, be a solid (e.g. powder, granules, pellets), semi-solid (e.g. gel, cream, paste) or liquid (e.g. solutions, suspensions, emulsions) product or composition, that is suitable for and/or intended for addition to animal feed in order to provide one or more beneficial effects. However, the animal feed supplement is not sufficient on its own to meet the nutritional need of the animal. The animal feed supplement and the various components of the animal feed supplement may, for example, be present in various concentrations and may, for example, be diluted upon addition to the animal feed composition. Although it may be preferred that the animal feed supplement is consumed by the animal together with its usual animal feed, the animal feed supplement may also be consumed by the animal separately to any animal feed, for example as a liquid (e.g. diluted in water) or in the form of a bolus or tablet.

The animal feed supplements and animal feed compositions described herein comprise at least one organosulfur compound (i.e. one or more organosulfur compound(s)). For example, the animal feed supplements and animal feed compositions may comprise two or more organosulfur compounds or three or more organosulfur compounds or four or more organosulfur compounds or five or more organosulfur compounds. For example, the animal feed supplements and animal feed compositions may comprise one, two, three, four or five organosulfur compounds. The total number of organosulfur compounds in the animal feed supplement or animal feed composition may be ten or less, or nine or less, or eight or less, or seven or less, or six or less, or five or less. The total number of organosulfur compounds in the animal feed supplement or animal feed composition may range from one to ten, for example from one to five, for example from one to four, for example from one to three. For example, the animal feed supplements and animal feed compositions described herein may comprise at least allicin. For example, the animal feed supplements and animal feed compositions described herein may comprise only one organosulfur compound, which may, for example, be allicin.

Organosulfur compounds are organic compounds that contain sulfur. In certain embodiments, at least one, for example all, of the organosulfur compound(s) in the animal feed supplement or animal feed composition may independently be selected from thioethers, thioesters, thioacetals, thiols, disulfides, polysulfides, sulfoxides, sulfones, thiosulfinates, sulfimides, sulfoximides, sulfonediimines, thioketones, thioaldehydes, sulfines, sulfenes, thiocarboxylic acids (including dithiocarboxylic acids), sulfonic acids, sulfinic acids, sulfenic acids, sulfonic esters, sulfinic esters, sulfenic esters, sulfonic amides, sulfinic amides, sulfenic amides, sulfonium compounds, oxosulfonium compounds, sulfonium ylides, oxosulfonium ylides, thiocarbonyl ylides, sulfuranes and persulfuranes. In certain embodiments, at least one, for example all, of the organosulfur compound(s) in the animal feed supplement or animal feed composition is/are independently selected from thioesters, sulfoxides, thioethers, disulfides, polysulfides (including trisulfides) and thiols. In certain embodiments, at least one, for example all, of the organosulfur compound(s) in the animal feed supplement or animal feed composition is/are independently selected from thioesters, sulfoxides, thioethers, disulfides and polysulfides (including trisulfides).

In certain embodiments, at least one, for example all, of the organosulfur compound(s) in the animal feed supplement or animal feed composition is/are independently selected from allicin, ajoene, alliin, allylpropyl disulfide, diallyl trisulfide, s-allylcysteine, vinyldithiines (3-vinyl-4H-1,2-dithiin and 2-vinyl-4H-1,3-dithiin), diallyl disulphide, and combinations of two or more thereof. In certain embodiments, at least one, for example the only, organosulfur compound in the animal feed supplement or animal feed composition is allicin.

Allicin is an organosulfur compound having the chemical formula C₆H₁₀OS₂ and structure shown below.

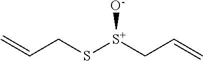

At least one organosulfur compound (e.g. allicin) may, for example, be obtained from garlic (Allium sativum) or another plant of the Allium genus, for example from the raw plant, from a dried plant, or from an extract of the plant. For example, all of the organosulfur compound(s) in the animal feed supplement or animal feed composition may be obtained from garlic (Allium sativum) or another plant of the Allium genus, for example from the raw plant, from a dried plant, or from an extract of the plant.

At least one organosulfur compound (e.g. allicin) may, for example, be obtained from garlic (Allium sativum) or another plant of the Allium genus. For example, all of the organosulfur compound(s) in the animal feed supplement or animal feed composition may be obtained from garlic (Allium sativum) or another plant of the Allium genus.

For example, at least one (e.g. all) of the organosulfur compound(s) in the animal feed supplement or animal feed composition may be obtained from an extract of an Allium species such as garlic (Allium sativum) (contained in the animal feed supplement or composition as part of a plant extract). The term extract encompasses aqueous extracts, non-aqueous extracts, alcoholic extracts, concentrates, oils, macerations, powders, granules and combinations of two or more thereof. For example, at least one (e.g. all) of the organosulfur compound(s) in the animal feed supplement or animal feed composition may be obtained from an extract of raw garlic, dried garlic or a combination thereof.

One or more (e.g. all) of the organosulfur compound(s) in the animal feed supplement or animal feed composition may, for example, be obtained from any of the subspecies and varieties of Allium that are currently known or are later discovered, such as garlic (Allium sativum), Allium ursinum, Allium fistulosum, Allium cepa and Allium tricoccum. For example, one or more (e.g. all) of the organosulfur compound(s) in the animal feed supplement or animal feed composition may independently be obtained from garlic of the subspecies ophioscorodon (hard neck garlic) and sativum (soft neck garlic). For example, one or more (e.g. all) of the organosulfur compound(s) in the animal feed supplement or animal feed composition may independently be obtained from porcelain garlics, rocambole garlics, purple stripe garlics, marbled purple stripe garlics, glazed purple stripe garlics, artichoke garlics, silverskin garlics, asiatic garlics, turban garlics and creole garlics. In particular, one or more (e.g. all) of the organosulfur compound(s) in the animal feed supplement or animal feed composition may be obtained from Allium sativum.

The Allium from which the organosulfur compound(s) may be obtained may, for example, have been treated or processed. For example, the Allium may be “aged” or “black” (e.g. aged or black garlic), obtained by storing the Allium in controlled conditions and heated under specific temperature, humidity and solvents, for example over several days or weeks, to cause the cloves to darken in colour after undergoing Maillard or browning reaction. For example, the Allium may be “dried” or “dehydrated”, obtained by heating the fresh or non-aged garlic to a temperature of between 30° C. and 120° C. and achieving a moisture content of about 3 to 10%, with or without transforming or converting its constituents into different compounds. For example, the Allium may be “fresh” or “non-aged” (e.g. fresh or non-aged garlic), obtained without undergoing special treatment or processing intentionally to transform or convert its constituents into different compounds. The fresh or non-aged Allium may, for example, have been treated or processed to remove the odour (deodourised) (e.g. deodourised garlic extract). Generally, an encapsulation or coating process can be applied to mask or reduce the odour. Alternatively or additionally, taste-masking ingredients such as green tea, parsley, basil, spinach etc. can be added to mask or reduce the odour in a composition.

One or more (e.g. all) of the organosulfur compound(s) in the animal feed supplement or animal feed composition may or may not be isolated and/or purified before incorporation into the animal feed supplement and animal feed compositions described herein. As such, in certain embodiments the animal feed supplement or animal feed compositions described herein may comprise raw garlic, dried garlic and/or garlic extracts.

In other embodiments, one or more (e.g. all) of the organosulfur compound(s) in the animal feed supplement or animal feed composition may be chemically synthesized. In certain embodiments, allicin may be obtained by treating a natural source of allinase to release allinase, contacting the treated source of allinase with alliin, whereby alliin is enzymatically converted to allicin, and optionally extracting the allicin. A suitable method is further described, for example, in WO 03/004668, the contents of which are incorporated herein by reference. In other embodiments, allicin may be completely chemically synthesized.

The animal feed supplements and animal feed compositions described herein comprise at least one essential oil and/or at least one component of an essential oil. For example, the animal feed supplements and animal feed compositions described herein may comprise at least one essential oil and at least one component of an essential oil. For example, the animal feed supplements and animal feed compositions described herein may comprise at least one essential oil but not comprise any components of an essential oil (separate to those components in the essential oil itself). For example, the animal feed supplements and animal feed compositions described herein may comprise at least one component of an essential oil but not comprise any essential oils.

The animal feed supplements and animal feed compositions may comprise two or more essential oils or three or more essential oils or four or more essential oils or five or more essential oils. Alternatively or additionally, the animal feed supplements and animal feed compositions may comprise two or more components of an essential oil or three or more components of an essential oil or four or more components of an essential oil or five or more components of an essential oil. When the animal feed supplement or animal feed composition comprises more than one component of an essential oil, each component of an essential oil may be a component of the same or different essential oil(s).

The total number of total essential oils and essential oil components in the animal feed supplement or animal feed composition may be ten or less, or nine or less, or eight or less, or seven or less, or six or less, or five or less. The total number of total essential oils and essential oil components in the animal feed supplement or animal feed composition may range from one to ten, for example from one to five, for example from one to four, for example from one to three. For example, the animal feed supplements and animal feed compositions may comprise a total of one, two, three, four or five essential oils and/or essential oil components.

The term “essential oil” refers to a liquid that is obtained from a plant. The essential oil may, for example, be a hydrophobic liquid. The essential oil may be obtained from one or more of the leaves, stems, flowers, seeds, bark, roots, or other parts of the plant. The essential oil may be obtained by distillation (e.g. steam distillation). Other processes for obtaining essential oils include expression, solvent extraction, sfumatura, absolute oil extraction, resin tapping, wax embedding, and cold pressing. Essential oils generally contain one or more of the compounds that give the plant its characteristic fragrance. Essential oils are also generally volatile.

Essential oils may, for example, include one or more organosulfur compounds. However, any organosulfur compounds present in the at least one essential oil and/or at least one component of an essential oil present in the animal feed supplement described herein are in addition to the at least one organosulfur compound present in the animal feed supplement and further described herein. Therefore, the at least one organosulfur compound is different to the at least one essential oil and/or the at least one component of an essential oil.

The term “component of an essential oil” refers to a compound that can be found in an essential oil but is not added to the animal feed supplement or animal feed composition as part of an essential oil. Each component of an essential oil present in the animal feed supplement or animal feed compositions described herein may, for example, independently have been obtained from (e.g. isolated from) an essential oil or have been chemically synthesized. For example all component(s) of an essential oil present in the animal feed supplement or animal feed composition described herein may have been chemically synthesized.

At least one essential oil, for example all essential oil(s), that are present in the animal feed supplement or animal feed composition may be selected from coriander (Coriandrum sativum) oil, nutmeg oil, wild carrot (Daucus carota) oil, pine oil, clove oil, oregano (Origanum vulgare) oil, eucalyptus oil, peppermint (Mentha piperita) oil, lemongrass oil, orange (Citrus sinensis) oil, geranium oil, lavender oil, grain oil, neroli oil (from Citrus aurantium subsp. amara or Bigaradia), sassafras oil, Jamaica pepper (Pimenta dioica) oil, cinnamon oil, basil (Ocimum basilicum) oil, bay leaf oil, rose oil, palmarosa (Cymbopogon martini) oil, citronella oil, lemon (Citrus limon) oil, and combinations of two or more thereof.

The nutmeg oil may be from any species of the Myristica genus, for example Myristica fragrans. The pine oil may be from any species of pine, for example Pinus sylvestris and Pinus tabuliformis. The clove oil may be from any species of clove, for example Syzgium aromaticum. The eucalyptus oil may be from any species of the Eucalyptus genus, for example Eucalyptus globulus, Eucalyptus kochii, Eucalyptus polybractea and Eucalyptus citriodora. The lemongrass oil may be from any species of the Cymbopogon genus, for example Cymbopogon citratus and Cymbopogon flexuosus. The geranium oil may be from any species of the Pelargonium genus, for example Pelargonium graveolens. The lavender oil may be from any species of the Lavandula genus, for example Lavandula angustifolia L. The grain oil may be from any species of grain, for example Oryza sativa and Triticum aestivum. The sassafras oil may be from any species of the Sassafras genus, for example Sassafras albidum. The cinnamon oil may be from any species of the Cinnamomum genus, for example Cinnamomum verum. The bay leaf oil may be from any species of bay leaf, for example Laurus nobilis. The rose oil may be from any species of the Rosa genus, for example Rosa damascene and Rosa centifolia. The citronella oil may be from any species of the Cymbopogon genus, for example Cymbopogon nardus and Cymbopogon winterianu.

At least one essential oil, for example all essential oil(s), that are present in the animal feed supplement or animal feed composition may be selected from coriander (Coriandrum sativum) oil, nutmeg oil, wild carrot (Daucus carota) oil, pine oil, clove oil, and combinations of two or more thereof.

In certain embodiments, at least one essential oil, for example the only essential oil, present in the animal feed supplement or animal feed composition is coriander oil.

The coriander oil may, for example, comprise one or more (e.g. all) of linalool, geraniol, and neryl acetate. For example, the coriander oil may comprise one or both of linalool and geraniol.

At least one component of an essential oil, for example all component(s) of essential oil(s), that are present in the animal feed supplement or animal feed composition may be selected from at least one component of coriander oil, at least one component of nutmeg oil, at least one component of wild carrot oil, at least one component of pine oil, at least one component of clove oil, at least one component of oregano oil, at least one component of eucalyptus oil, at least one component of peppermint oil, at least one component of lemongrass oil, at least one component of orange oil, at least one component of geranium oil, at least one component of lavender oil, at least one component of grain oil, at least one component of neroli oil, at least one component of sassafras oil, at least one component of Jamaica pepper oil, at least one component of cinnamon oil, at least one component of basil oil, at least one component of bay leaf oil, at least one component of rose oil, at least one component of palmarosa oil, at least one component of citronella oil, at least one component of lemon oil, and combinations of two or more components of one or more of coriander oil, nutmeg oil, wild carrot oil, pine oil, clove oil, oregano oil, eucalyptus oil, peppermint oil, lemongrass oil, orange oil, geranium oil, lavender oil, grain oil, neroli oil, sassafras oil, Jamaica pepper oil, cinnamon oil, basil oil, bay leaf oil, rose oil, palmarosa oil, citronella oil, and lemon oil.

In certain embodiments, at least one component of an essential oil, for example all component(s) of an essential oil, that are present in the animal feed supplement or animal feed composition may be selected from at least one component of coriander oil, at least one component of nutmeg oil, at least one component of wild carrot oil, at least one component of pine oil, at least one component of clove oil, and combinations of two or more components of one or more of coriander oil, nutmeg oil, wild carrot oil, pine oil, and clove oil.

In certain embodiments, at least one component of an essential oil, for example the only component or component(s) of an essential oil, that are present in the animal feed supplement or animal feed composition may be a component or component(s) of coriander oil (e.g. linalool, geraniol, and/or neryl acetate).

In certain embodiments, at least one essential oil, for example all essential oil(s), present in the animal feed supplement or animal feed composition comprise an acetate ester. The acetate esters have the structure R—O—(C═O)—CH₃, where R is a cyclic or linear (including straight chain and branched chain), saturated or unsaturated, hydrocarbon chain which may, for example, include from two to twenty carbon atoms, for example from five to fifteen carbon atoms, for example from eight to twelve carbon atoms. In certain embodiments, R is an unsaturated linear hydrocarbon chain including from five to fifteen carbon atoms, for example from eight to twelve carbon atoms.

In certain embodiments, at least one component of an essential oil, for example all components of an essential oil, present in the animal feed supplement or animal feed composition are acetate ester(s). The acetate esters have the structure R—O—(C═O)—CH₃, where R is a cyclic or linear (including straight chain and branched chain), saturated or unsaturated, hydrocarbon chain which may, for example, include from two to twenty carbon atoms, for example from five to fifteen carbon atoms, for example from eight to twelve carbon atoms. In certain embodiments, R is an unsaturated linear hydrocarbon chain including from five to fifteen carbon atoms, for example from eight to twelve carbon atoms.

In certain embodiments, at least one essential oil, for example all essential oil(s), present in the animal feed supplement or animal feed composition comprise an alkene alcohol (a compound with an —OH group substituted on an alkene backbone). The alkene may be cyclic or linear (including straight chain and branched chain) unsaturated hydrocarbon which may, for example, include from two to twenty carbon atoms, for example from five to fifteen carbon atoms, for example from eight to twelve carbon atoms. In certain embodiments, the alkene is a linear straight chain unsaturated hydrocarbon containing from five to fifteen carbon atoms, for example from eight to twelve carbon atoms.

In certain embodiments, at least one component of an essential oil, for example all components of an essential oil, present in the animal feed supplement or animal feed composition are alkene alcohol(s) (compounds with an —OH group substituted on an alkene backbone). The alkene may be cyclic or linear (including straight chain and branched chain) unsaturated hydrocarbon which may, for example, include from two to twenty carbon atoms, for example from five to fifteen carbon atoms, for example from eight to twelve carbon atoms. In certain embodiments, the alkene is a linear straight chain unsaturated hydrocarbon containing from five to fifteen carbon atoms, for example from eight to twelve carbon atoms.

In certain embodiments, at least one essential oil, for example all essential oil(s) present in the animal feed supplement or animal feed composition comprise a substituted or unsubstituted guaiacol. Guaiacol has the formula C₆H₄(OH)(OCH₃). The guaiacol may, for example, be substituted with a cyclic or linear (including straight chain and branched chain), saturated or unsaturated, hydrocarbon chain which may, for example, include from one to ten carbon atoms, for example from one to five carbon atoms, for example from one to three carbon atoms. In certain embodiments, the guaiacol is substituted with a linear hydrocarbon chain including from one to ten carbon atoms, for example from one to five carbon atoms. In certain embodiments, the guaiacol is substituted with an unsaturated linear hydrocarbon chain including from two to ten carbon atoms, for example from two to five carbon atoms.

In certain embodiments, at least one component of an essential oil, for example all components of an essential oil present in the animal feed supplement or animal feed composition are substituted or unsubstituted guaiacol(s). Guaiacol has the formula C₆H₄(OH)(OCH₃). The guaiacol may, for example, be substituted with a cyclic or linear (including straight chain and branched chain), saturated or unsaturated, hydrocarbon chain which may, for example, include from one to ten carbon atoms, for example from one to five carbon atoms, for example from one to three carbon atoms. In certain embodiments, the guaiacol is substituted with a linear hydrocarbon chain including from one to ten carbon atoms, for example from one to five carbon atoms. In certain embodiments, the guaiacol is substituted with an unsaturated linear hydrocarbon chain including from two to ten carbon atoms, for example from two to five carbon atoms.

In certain embodiments, at least one essential oil, for example all essential oil(s), present in the animal feed supplement or animal feed composition comprise bornyl acetate, geranyl acetate, eugenol, linalool, geraniol, neryl acetate, or a combination of two or more thereof. For example, at least one essential oil, for example all essential oil(s) present in the animal feed supplement or animal feed composition comprise bornyl acetate, geranyl acetate, eugenol, or a combination of two or more thereof.

In certain embodiments, at least one component of an essential oil, for example all components of an essential oil, present in the animal feed supplement or animal feed composition are selected from bornyl acetate, geranyl acetate, eugenol, linalool, geraniol, neryl acetate, and combinations of two or more thereof. For example, at least one component of an essential oil, for example all components of an essential oil present in the animal feed supplement or animal feed composition are selected from bornyl acetate, geranyl acetate, eugenol, or a combination of two or more thereof.

Bornyl acetate has the chemical formula C₁₂H₂₀O₂ and the structure shown below. It is a component of pine oil, particularly from pine needles and is primarily responsible for its odour.

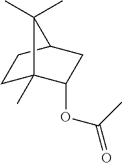

Similar to geranyl acetate, bornyl acetate is present in a range of plant species and can be extracted with a wide range of common techniques that include steam distillation, hydrocarbon solvent extraction, supercritical water and supercritical carbon dioxide. Bornyl acetate may also be synthesized via reaction of borneol with acetic acid.

Geranyl acetate has the chemical formula C₁₂H₂₀O₂ and the structure shown below. It is a component of a number of essential oils, including coriander oil, wild carrot oil, lemongrass oil, orange oil, geranium oil, lavender oil, grain oil, neroli oil, coriander oil, and sassafras oil.

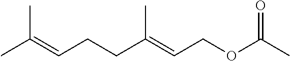

Geranyl acetate can be obtained in various degrees of purity by fractional distillation of essential oils or plant source. Fractionation can be via a number of techniques that include steam distillation, supercritical water and supercritical carbon dioxide. Geranyl acetate is an ester of geraniol and thus can also be prepared semi-synthetically by the condensation of the commonly occurring natural terpene geraniol with acetic acid.

Eugenol has the chemical formula C₁₀H₁₂O₂ and the structure shown below. It is a component of a number of essential oils, including nutmeg oil, clove oil, and Jamaica pepper (Pimenta dioica) oil.

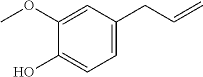

Eugenol is typically manufactured by fractionation of clove oil via steam distillation. Eugenol can also be extracted from other plant sources including but not limited to nutmeg, cinnamon, basil and bay leaf. While typical manufacture is via steam distillation extraction, it has also been shown to be possible via other common techniques such as hydrocarbon solvent extraction, supercritical carbon dioxide and subcritical water extraction. Eugenol may also be prepared via a biosynthesis process starting with the amino acid tyrosine.

Linalool has the chemical formula C₁₀H₁₃O and the structure shown below. It is a component of a number of essential oils, including coriander oil, lemongrass oil, and orange oil.

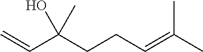

Linalool is commonly manufactured by fractionation distillation of coriander oil. Linalool can also be extracted from plant sources including but not limited to rosewood, citrus fruits and birch trees. It is also possible to manufacture linalool using other known methods such as hydrocarbon solvent extraction, supercritical water and supercritical carbon dioxide. Linalool may also be prepared via a biosynthesis process with isopentenyl pyrophosphate.

Geraniol has the chemical formula C₁₀H₁₃O and the structure shown below. It is a component of a number of essential oils, including coriander oil, rose oil, palmarosa oil, citronella oil, geranium oil, and lemon oil.

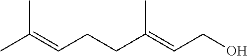

Geraniol is typically manufactured by fractionation distillation of essential oils including but not limited to rose oil, citronella oil and palmarosa oil. It is also possible to manufacture geraniol using other known methods such as hydrocarbon solvent extraction, supercritical water and supercritical carbon dioxide. Geraniol may also be prepared synthetically using linalool or pinene.

Neryl acetate has the chemical formula C₁₂H₂₀O₂ and the structure shown below. It is a component of a number of essential oils, including coriander oil.

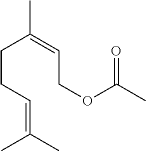

Neryl acetate is commonly manufactured by fractionation distillation of plant sources including but not limited to citrus fruits, nutmeg and grape. It is also possible to manufacture neryl acetate using other known methods such as hydrocarbon solvent extraction, supercritical water and supercritical carbon dioxide. Neryl acetate may also be prepared synthetically using geraniol and sodium acetate with acetic anhydride.

In certain embodiments, the at least one organosulfur compound is allicin and the at least one essential oil or at least one component of an essential oil is coriander oil. In certain embodiments, the at least one organosulfur compound is allicin and the at least one essential oil or at least one component of an essential oil is bornyl acetate. In certain embodiments, the at least one organosulfur compound is allicin and the at least one essential oil or at least one component of an essential oil is geranyl acetate. In certain embodiments, the at least one organosulfur compound is allicin and the at least one essential oil or at least one component of an essential oil is eugenol. In certain embodiments, the at least one organosulfur compound is allicin and the at least one essential oil or at least one component of an essential oil is linalool. In certain embodiments, the at least one organosulfur compound is allicin and the at least one essential oil or at least one component of an essential oil is geraniol. In certain embodiments, the at least one organosulfur compound is allicin and the at least one essential oil or at least one component of an essential oil is neryl acetate. In certain embodiments, the at least one organosulfur compound is allicin and the at least one essential oil or at least one component of an essential oil is an essential oil comprising one or more of bornyl acetate, geranyl acetate, eugenol, linalool, geraniol, and neryl acetate. In certain embodiments, the at least one organosulfur compound is allicin and the at least one essential oil or at least one component of an essential oil is selected from one or more of bornyl acetate, geranyl acetate, eugenol, linalool, geraniol, and neryl acetate. In certain embodiments, the at least one organosulfur compound is allicin and the at least one essential oil or at least one component of an essential oil is an essential oil comprising one or more of bornyl acetate, geranyl acetate, and eugenol. In certain embodiments, the at least one organosulfur compound is allicin and the at least one essential oil or at least one component of an essential oil is selected from one or more of bornyl acetate, geranyl acetate, and eugenol. In these embodiments, the allicin may be part of a garlic extract.

In certain embodiments, the animal feed supplement described herein excludes animal feed compositions comprising eugenol and garlic extract.

In certain embodiments, the animal feed supplements and animal feed compositions described herein further comprise at least one bioflavonoid. For example, the animal feed supplements and animal feed compositions described herein may further comprise one or more, or two or more, or three or more, or four or more, or five or more bioflavonoid(s).

For example, the animal feed supplements and animal feed compositions described herein may further comprise one, two, three, four, or five bioflavonoids. The total number of bioflavonoids in the animal feed supplement or animal feed composition may be ten or less, or nine or less, or eight or less, or seven or less, or six or less. The total number of bioflavonoids in the animal feed supplement or animal feed composition may, for example, range from one to ten, for example from one to five, for example from one to four, for example from one to three.

The term bioflavonoid refers to a class of plant and fungus secondary metabolites and having the general structure of a 15-carbon skeleton consisting of two phenyl rings (A and B) and heterocyclic ring (C), sometimes abbreviated as C6-C3-C6. The term bioflavonoid includes anthoxanthins (including flavones and flavonols), flavanones, flavanonols, flavans and anthocyanidins. The term bioflavonoid also includes compounds having a flavone backbone (2-phenyl-1,4-benzopyrone), an isoflavan backbone (3-phenylchromen-4-one) or a neoflavan backbone (4-phenylcoumarine).

In certain embodiments, at least one bioflavonoid, for example all bioflavonoids, present in the animal feed supplement or animal feed composition, is/are selected from anthoxanthins (including flavones and flavonols), flavanones (including flavanone glycosides), flavanonols, flavans, isoflavones, anthocyanidins, proanthocyanidins, and combinations of two or more thereof. In certain embodiments, at least one bioflavonoid, for example all bioflavonoids present in the animal feed supplement or animal feed composition, is/are selected from anthoxanthins, flavanones (including flavanone glycosides), and combinations thereof. In certain embodiments, at least one bioflavonoid, for example all bioflavonoids, present in the animal feed supplement or animal feed composition, is/are selected from flavones, flavanones, and combinations thereof. The flavones and flavanones may, for example, independently be flavone glycosides and flavanone glycosides respectively.

In certain embodiments, at least one bioflavonoid, for example all bioflavonoids, present in the animal fed supplement or animal feed composition may be selected from the group consisting of naringin, neohesperidin, eriocitrin, isonaringin, naringenin, hesperidin, roifolin, diosmin, didymin, hesperetin, poncirin, catechin, rutin, acacetin, genistein, kaempferol, quercetin, epicatechin, gallocatechin, epigallocatechin, catechin gallate, epicatechin gallate, epigallocatechin gallate, gallocatechin gallate, and combinations thereof. In certain embodiments, at least one bioflavonoid, for example all bioflavonoids, present in the animal fed supplement or animal feed composition may be selected from the group consisting of naringin, neohesperidin, eriocitrin, isonaringin, naringenin, hesperidin, roifolin, diosmin, didymin, hesperetin, poncirin, and combinations thereof. In certain embodiments, at least one bioflavonoid, for example all bioflavonoids, present in the animal fed supplement or animal feed composition may be selected from naringin, neohesperidin, and a combination thereof.

The bioflavonoid(s), may, for example, be obtained from a part of a plant (e.g. fruit or vegetable). For example, the bioflavonoids, may be obtained from a plant extract (contained in the animal feed supplement or composition as part of a plant extract). The term extract encompasses aqueous extracts, non-aqueous extracts, alcoholic extracts, concentrates, oils, macerations, powders, granules and combinations of two or more thereof.

For example, flavonols may be obtained from tomatoes, beans, almonds and/or turnips. For example, flavan-3-ols may be obtained from peaches, plums, strawberries and/or green tea. For example, flavones may be obtained from watermelon and/or peppers. For example, flavonones may be obtained from a Citrus species fruit such as Citrus x aurantium. For example, anthocyanidins may be obtained from blueberries, bananas, strawberries, cranberries and/or plums. The bioflavonoid(s), may, for example, be obtained from a Citrus species fruit such as oranges, lemons, grapefruit, pomelo or limes. In particular, the bioflavonoid(s), may be obtained from oranges. The bioflavonoid(s), may, for example, be obtained from a Punica species fruit such as pomegranate (Punica granatum) or Socotra pomegranate (Punica protopunica). In particular, the bioflavonoid(s), may be obtained from pomegranates (Punica granatum). The bioflavonoid(s), may, for example, be obtained from a part (e.g. leaves) of a Camellia species plant such as Camellia sinensis, Camellia taliensis, Camellia oleifera, Camellia assimilis, Camellia azalea, Camellia brevistyla, Camellia caudata, Camellia chekiangoleosa, Camellia chrysantha, Camellia chrysanthoides, Camellia connata, Camellia crapnelliana, Camellia cuspidata, Camellia euphlebia, Camellia euryoides, Camellia flava, Camellia fleuryi, Camellia forrestii, Camellia fraterna, Camellia furfuracea, Camellia gilbertii, Camellia granthamiana, Camellia gnijsii, Camellia hengchunensis, Camellia hiemalis, Camellia hongkongensis, Camellia irrawadiensis, Camellia japonica, Camellia kissii, Camellia lutchuensis, Camellia miyagii, Camellia nitidissima, Camellia nokoensis, Camellia parviflora, Camellia pitardii, Camellia pleurocarpa, Camellia polyodonta, Camellia pubupetala, Camellia reticulata, Camellia rosiflora, Camellia rusticana, Camellia salicifolia, Camellia saluenensis, Camellia sasanqua, Camellia semiserrata, Camellia trasnokoensis, Camellia tsaii, Camellia tunghinensis, Camellia vietnamensis, Camellia x williamsii and Camellia yunnanensis. In particular, the bioflavonoid(s) may be obtained from Camellia sinensis (tea plant). Any subspecies or variety of Camellia sinensis may be used. The part of the Camellia sinensis (e.g. leaves) may be untreated or may be treated, for example, by steaming, withering, rolling, oxidation, fermentation and/or drying. The bioflavonoid(s), may, for example, be obtained from green tea (Camellia sinensis) leaves. For example, the bioflavonoid(s), may be obtained from dried Citrus fruit, dried Punica fruit or dried Camellia plant parts (e.g. leaves). For example, the bioflavonoid(s), may be obtained from raw Citrus fruit, raw Punica fruit or raw Camellia plant parts (e.g. leaves).

The bioflavonoid(s), may or may not be isolated and/or purified before incorporation into the animal feed supplement and animal feed compositions described herein. As such, in certain embodiments the animal feed supplement or animal feed compositions described herein may comprise raw Citrus fruit, dried Citrus fruit and/or Citrus fruit extracts, or raw Punica fruit, dried Punica fruit and/or Punica fruit extract, or raw Camellia plant, dried Camellia plant and/or Camellia plant extracts. In other embodiments, the bioflavonoid(s), may each independently be chemically synthesized.

In certain embodiments, the weight ratio of total organosulfur compounds to total essential oils and essential oil components ranges from about 10:1 to about 1:400. For example, the weight ratio of total organosulfur compounds to total essential oils and essential oil components may range from about 10:1 to about 1:350 or from about 10:1 to about 1:300 or from about 10:1 to about 1:250 or from about 10:1 to about 1:200 or from about 10:1 to about 1:175 or from about 5:1 to about 1:150 or from about 1:1 to about 1:125 or from about 1:2 to about 1:100 or from about 1:5 to about 1:75 or from about 1:10 to about 1:50 or from about 1:15 to about 1:40 or from about 1:15 to about 1:20. For example, the weight ratio of total organosulfur compounds to total essential oils and essential oil components may range from about 1:1 to about 1:150 or from about 1:1 to about 1:100 or from about 1:1 to about 1:50 or from about 1:1 to about 1:20. For example, the weight ratio of total organosulfur compounds to total essential oils and essential oil components may range from about 1:5 to about 1:150 or from about 1:5 to about 1:100 or from about 1:5 to about 1:50 or from about 1:5 to about 1:20. For example, the weight ratio of total organosulfur compounds to total essential oils and essential oil components may range from about 1:10 to about 1:150 or from about 1:10 to about 1:100 or from about 1:10 to about 1:50 or from about 1:10 to about 1:20. For example, the weight ratio of total organosulfur compounds to total essential oils and essential oil components may range from about 1:15 to about 1:150 or from about 1:15 to about 1:100 or from about 1:15 to about 1:50 or from about 1:15 to about 1:40 or from about 1:15 to about 1:20.

In certain embodiments, the weight ratio of allicin to total essential oils and essential oil components ranges from about 10:1 to about 1:400. For example, the weight ratio of allicin to total essential oils and essential oil components may range from about 10:1 to about 1:350 or from about 10:1 to about 1:300 or from about 10:1 to about 1:250 or from about 10:1 to about 1:200 or from about 10:1 to about 1:175 or from about 5:1 to about 1:150 or from about 1:1 to about 1:125 or from about 1:2 to about 1:100 or from about 1:5 to about 1:75 or from about 1:10 to about 1:50 or from about 1:15 to about 1:40 or from about 1:15 to about 1:20. For example, the weight ratio of allicin to total essential oils and essential oil components may range from about 1:1 to about 1:150 or from about 1:1 to about 1:100 or from about 1:1 to about 1:50 or from about 1:1 to about 1:20. For example, the weight ratio of allicin to total essential oils and essential oil components may range from about 1:5 to about 1:150 or from about 1:5 to about 1:100 or from about 1:5 to about 1:50 or from about 1:5 to about 1:20. For example, the weight ratio of allicin to total essential oils and essential oil components may range from about 1:10 to about 1:150 or from about 1:10 to about 1:100 or from about 1:10 to about 1:50 or from about 1:10 to about 1:20. For example, the weight ratio of allicin to total essential oils and essential oil components may range from about 1:15 to about 1:150 or from about 1:15 to about 1:100 or from about 1:15 to about 1:50 or from about 1:15 to about 1:40 or from about 1:15 to about 1:20.

In certain embodiments, the animal feed supplement comprises equal to or greater than about 0.0001 wt % total organosulfur compounds. For example, the animal feed supplement may comprise equal to or greater than about 0.001 wt % or equal to or greater than about 0.01 wt % or equal to or greater than about 0.1 wt % or equal to or greater than about 0.5 wt % or equal to or greater than about 1.0 wt % or equal to or greater than about 1.5 wt % or equal to or greater than about 2 wt % total organosulfur compounds.

In certain embodiments, the animal feed supplement comprises equal to or less than about 20.0 wt % total organosulfur compounds. For example, the animal feed supplement may comprise equal to or less than about 18.0 wt % or equal to or less than about 16.0 wt % or equal to or less than about 15.5 wt % or equal to or less than about 14.0 wt % or equal to or less than about 12.0 wt % or equal to or less than about 10.0 wt % or equal to or less than about 8.0 wt % or equal to or less than about 6.0 wt % or equal to or less than about 5.0 wt % total organosulfur compounds.

For example, the animal feed supplement may comprise from about 0.0001 wt % to about 20.0 wt % or from about 0.1 wt % to about 15.0 wt % or from about 1.0 wt % to about 10.0 wt % total organosulfur compounds.

In certain embodiments, the animal feed supplement comprises equal to or greater than about 0.0001 wt % allicin. For example, the animal feed supplement may comprise equal to or greater than about 0.001 wt % or equal to or greater than about 0.01 wt % or equal to or greater than about 0.1 wt % or equal to or greater than about 0.5 wt % or equal to or greater than about 1.0 wt % or equal to or greater than about 1.5 wt % or equal to or greater than about 2 wt % allicin.

In certain embodiments, the animal feed supplement comprises equal to or less than about 20.0 wt % allicin. For example, the animal feed supplement may comprise equal to or less than about 18.0 wt % or equal to or less than about 16.0 wt % or equal to or less than about 15.0 wt % or equal to or less than about 14.0 wt % or equal to or less than about 12.0 wt % or equal to or less than about 10.0 wt % or equal to or less than about 8.0 wt % or equal to or less than about 6.0 wt % or equal to or less than about 5.0 wt % allicin.

For example, the animal feed supplement may comprise from about 0.0001 wt % to about 20.0 wt % or from about 0.1 wt % to about 15.0 wt % or from about 1.0 wt % to about 10.0 wt % or from about 1.5 wt % to about 5.0 wt % allicin.

In certain embodiments, the animal feed supplement comprises equal to or greater than about 0.0001 wt % total essential oils and essential oil components. For example, the animal feed supplement may comprise equal to or greater than about 0.001 wt % or equal to or greater than about 0.01 wt % or equal to or greater than about 0.1 wt % or equal to or greater than about 0.5 wt % or equal to or greater than about 1.0 wt % or equal to or greater than about 1.5 wt % or equal to or greater than about 2 wt % total essential oils and essential oil components.

In certain embodiments, the animal feed supplement comprises equal to or less than about 20.0 wt % total essential oils and essential oil components. For example, the animal feed supplement may comprise equal to or less than about 18.0 wt % or equal to or less than about 16.0 wt % or equal to or less than about 15.0 wt % or equal to or less than about 14.0 wt % or equal to or less than about 12.0 wt % or equal to or less than about 10.0 wt % or equal to or less than about 8.0 wt % or equal to or less than about 6.0 wt % or equal to or less than about 5.0 wt % total essential oils and essential oil components.

For example, the animal feed supplement may comprise from about 0.0001 wt % to about 20.0 wt % or from about 0.001 wt % to about 15.0 wt % or from about 0.01 wt % to about 10.0 wt % or from about 0.1 wt % to about 5.0 wt % total essential oils and essential oil components.

In certain embodiments, the animal feed supplement comprises equal to or greater than about 0.0001 wt % total bornyl acetate, geranyl acetate, and eugenol. For example, the animal feed supplement may comprise equal to or greater than about 0.001 wt % or equal to or greater than about 0.01 wt % or equal to or greater than about 0.1 wt % or equal to or greater than about 0.5 wt % or equal to or greater than about 1.0 wt % or equal to or greater than about 1.5 wt % or equal to or greater than about 2 wt % total bornyl acetate, geranyl acetate, and eugenol.

In certain embodiments, the animal feed supplement comprises equal to or less than about 20.0 wt % total bornyl acetate, geranyl acetate, and eugenol. For example, the animal feed supplement may comprise equal to or less than about 18.0 wt % or equal to or less than about 16.0 wt % or equal to or less than about 15.0 wt % or equal to or less than about 14.0 wt % or equal to or less than about 12.0 wt % or equal to or less than about 10.0 wt % or equal to or less than about 8.0 wt % or equal to or less than about 6.0 wt % or equal to or less than about 5.0 wt % total bornyl acetate, geranyl acetate, and eugenol.

For example, the animal feed supplement may comprise from about 0.0001 wt % to about 20.0 wt % or from about 0.001 wt % to about 15.0 wt % or from about 0.01 wt % to about 10.0 wt % total bornyl acetate, geranyl acetate, and eugenol.

In certain embodiments, the animal feed supplement comprises equal to or greater than about 0.0001 wt % total bioflavonoids. For example, the animal feed supplement may comprise equal to or greater than about 0.001 wt % or equal to or greater than about 0.01 wt % or equal to or greater than about 0.1 wt % or equal to or greater than about 0.5 wt % or equal to or greater than about 1.0 wt % or equal to or greater than about 1.5 wt % or equal to or greater than about 2 wt % total bioflavonoids.

In certain embodiments, the animal feed supplement comprises equal to or less than about 20.0 wt % total bioflavonoids. For example, the animal feed supplement may comprise equal to or less than about 18.0 wt % or equal to or less than about 16.0 wt % or equal to or less than about 15.0 wt % or equal to or less than about 14.0 wt % or equal to or less than about 12.0 wt % or equal to or less than about 10.0 wt % or equal to or less than about 8.0 wt % or equal to or less than about 6.0 wt % or equal to or less than about 5.0 wt % total bioflavonoids.

For example, the animal feed supplement may comprise from about 0.0001 wt % to about 20.0 wt % or from about 0.001 wt % to about 15.0 wt % or from about 0.01 wt % to about 10.0 wt % total bioflavonoids.

The animal feed supplement may, for example, comprise other components in addition to the active material such as, for example, flavourings, colourants, stabilizers, antioxidants, buffers, emulsifiers, dispersants, thickeners, solubilising agents, micronutrients (for example selenium), vitamins, other feed material (for example carbohydrates such as sugars and starches), soluble and insoluble fibres, cellulose, lignocellulose, cereal grains, cereal brans, grain middlings, grain husks, fruit and vegetable seeds, skins, peels, and the like.

Animal Feed Composition

The animal feed supplement disclosed herein (including all embodiments and any combination of embodiments) may be combined with an animal feed to form an animal feed composition.

The animal feed may, for example, be any composition suitable for providing nutrition to an animal, particularly a ruminant animal or a pseudo-ruminant animal. For example, the animal feed may be suitable for any ruminant animal, for example cows, goats, sheep, yaks, deer or antelope. For example, the animal feed may be suitable for any pseudo-ruminant animal, for example, camels and hippopotami. For example, the animal feed may be suitable for any monogastric animal, for example kangaroos, rats, dogs, pigs, cats, horses, birds (such as pigeons, penguins) and rabbits. For example, the animal feed may be suitable for monogastric herbivores such as kangaroos, horses and rabbits.

The animal feed may be solid (e.g. powder, granules, pellets), semi-solid (e.g. gel, cream, paste) or liquid (e.g. solutions, suspensions, emulsions). The animal feed supplement may independently be solid, semi-solid (e.g. gel, cream, paste) or liquid (e.g. solutions, suspensions, emulsions). For example, the animal feed and animal feed supplement may both be liquid or both be semi-solid or both be solid. Alternatively, the animal feed and animal feed supplement may each be a different physical state. For example, the animal feed may be solid or semi-solid and the animal feed supplement may be liquid. The animal feed supplement may, for example, be used to “top-dress” (added on top) an animal feedlot ration or may be used to blend into a total mixed ration. The animal feed supplement may, for example, be added to the drinking water of the animal. In certain embodiments, the animal feed supplement may be added to the drinking water of the animal immediately before ingestion, for example up to 1 hour before ingestion or up to 30 minutes before ingestion or up to 15 minutes before ingestion or up to 5 minutes before ingestion.

The three main types of animal feed include roughages, concentrates and mixed feeds. In general, roughages contain a high percentage of crude fibre and a low percentage of digestible nutrients. For example, roughages may be defined as containing equal to or greater than 20 wt % crude fibre and equal to or less than 60 wt % total digestible nutrients. Roughages may include, for example, dry roughages (e.g. hay, straw, artificially dehydrated forages containing at least 90 wt % dry matter), silages (formed from green forages such as grass, alfalfa, sorghum and corn and preserved in a silo at dry matter contents of 20 to 50%), and pastures (e.g. green growing pastures providing forage that has a high water content and only 20 to 30% dry matter). The two basic types of roughages include grasses and legumes. Grasses are generally higher in fibre and dry matter than legumes. Legumes are generally higher in proteins, energy, vitamins and minerals.

Concentrates are the opposite of roughages and contain a low percentage of crude fibre and a high percentage of digestible nutrients. For example, concentrates may be defined as containing less than 20 wt % crude fibre and greater than 60 wt % total digestible nutrients. Concentrates may include, for example, energy-rich grains and molasses. Corn, oats, barley and milo (sorghum grain) are energy-rich grains, containing about 70 to 80 wt % total digestible nutrients. Concentrates also include, for example, wheat bran, rice bran, wheat middlings, rye middlings and rice polish.

Mixed feeds are generally a mixture of roughages and concentrates to provide “complete” balanced rations and may be either high or low in energy, protein or fibre.

The at least one organosulfur compound and at least one essential oil and/or at least one essential oil component may, for example, be combined with animal feed in various amounts depending on the total amount of organosulfur compound(s) and essential oil(s) and/or essential oil component(s) that are intended to be administered to the animal. For example, the total amount of organosulfur compound(s) and essential oil(s) and/or essential oil component(s) may be enough such that up to 10 grams total organosulfur compound(s) and essential oil(s) and/or essential oil component(s) may be administered to one animal per day.

The concentration of total organosulfur compounds present in the animal feed supplements or animal feed compositions described herein may, for example, be higher than the concentration of each respective organosulfur compound naturally found in Allium spp.

The animal feed composition may, for example, comprise from about 0.0001 wt % to about 10 wt % of total organosulfur compounds, based on the total dry weight of the animal feed composition. The animal feed composition may, for example, comprise from about 0.01 wt % to about 10 wt % of total organosulfur compounds, based on the total dry weight of the animal feed composition. For example, the animal feed composition may comprise from about 0.1 wt % to about 9.5 wt % or from about 0.4 wt % to about 9.5 wt % or from about 0.5 wt % to about 9 wt % or from about 0.6 wt % to about 8.5 wt % or from about 0.7 wt % to about 8 wt % or from about 0.8 wt % to about 7.5 wt % or from about 0.9 wt % to about 7 wt % or from about 1 wt % to about 6 wt % or from about 1.5 wt % to about 5.5 wt % or from about 2 wt % to about 5 wt % or from about 2.5 wt % to about 4.5 wt % or from about 3 wt % to about 4 wt % total organosulfur compounds based on the total dry weight of the animal feed composition. For example, the animal feed composition may comprise from about 0.0001 wt % to about 1.0 wt % or from about 0.001 wt % to about 0.8 wt % or from about 0.01 wt % to about 0.5 wt % or from about 0.1 wt % to about 0.4 wt % of total organosulfur compounds based on the total dry weight of the animal feed composition.

The animal feed composition may, for example, comprise from about 0.0001 wt % to about 10 wt % of allicin, based on the total dry weight of the animal feed composition. The animal feed composition may, for example, comprise from about 0.01 wt % to about 10 wt % of allicin, based on the total dry weight of the animal feed composition. For example, the animal feed composition may comprise from about 0.001 wt % to about 9.5 wt % or from about 0.005 wt % to about 9 wt % or from about 0.01 wt % to about 8.5 wt % or from about 0.05 wt % to about 8 wt % or from about 0.1 wt % to about 7.5 wt % or from about 0.9 wt % to about 7 wt % or from about 1 wt % to about 6 wt % or from about 1.5 wt % to about 5.5 wt % or from about 2 wt % to about 5 wt % or from about 2.5 wt % to about 4.5 wt % or from about 3 wt % to about 4 wt % allicin based on the total dry weight of the animal feed composition. For example, the animal feed composition may comprise from about 0.4 wt % to about 9.5 wt % or from about 0.5 wt % to about 9 wt % or from about 0.6 wt % to about 8.5 wt % or from about 0.7 wt % to about 8 wt % or from about 0.8 wt % to about 7.5 wt % or from about 0.9 wt % to about 7 wt % or from about 1 wt % to about 6 wt % or from about 1.5 wt % to about 5.5 wt % or from about 2 wt % to about 5 wt % or from about 2.5 wt % to about 4.5 wt % or from about 3 wt % to about 4 wt % allicin based on the total dry weight of the animal feed composition. For example, the animal feed composition may comprise from about 0.0001 wt % to about 1.0 wt % or from about 0.001 wt % to about 0.8 wt % or from about 0.01 wt % to about 0.5 wt % or from about 0.1 wt % to about 0.4 wt % of allicin based on the total dry weight of the animal feed composition.

The concentration of total essential oil(s) and/or essential oil component(s) present in the animal feed supplements or animal feed compositions described herein may, for example, be higher than the concentration of each respective essential oil and/or essential oil component naturally found in plants.

The animal feed composition may, for example, comprise from about 0.0001 wt % to about 10 wt % total essential oil(s) and/or essential oil component(s), based on the total dry weight of the animal feed composition. The animal feed composition may, for example, comprise from about 0.1 wt % to about 10 wt % total essential oil(s) and/or essential oil component(s), based on the total dry weight of the animal feed composition. For example, the animal feed composition may comprise from about 0.001 wt % to about 10 wt % or from about 0.005 wt % to about 10 wt % or from about 0.01 wt % to about 9.5 wt % or from about 0.05 wt % to about 9 wt % or from about 0.1 wt % to about 8.5 wt % or from about 0.7 wt % to about 8 wt % or from about 0.8 wt % to about 7.5 wt % or from about 0.9 wt % to about 7 wt % or from about 1 wt % to about 6 wt % or from about 1.5 wt % to about 5.5 wt % or from about 2 wt % to about 5 wt % or from about 2.5 wt % to about 4.5 wt % or from about 3 wt % to about 4 wt % total essential oil(s) and/or essential oil component(s) based on the total dry weight of the animal feed composition. For example, the animal feed composition may comprise from about 0.2 wt % to about 10 wt % or from about 0.3 wt % to about 10 wt % or from about 0.4 wt % to about 9.5 wt % or from about 0.5 wt % to about 9 wt % or from about 0.6 wt % to about 8.5 wt % or from about 0.7 wt % to about 8 wt % or from about 0.8 wt % to about 7.5 wt % or from about 0.9 wt % to about 7 wt % or from about 1 wt % to about 6 wt % or from about 1.5 wt % to about 5.5 wt % or from about 2 wt % to about 5 wt % or from about 2.5 wt % to about 4.5 wt % or from about 3 wt % to about 4 wt % total essential oil(s) and/or essential oil component(s) based on the total dry weight of the animal feed composition. For example, the animal feed composition may comprise from about 2.0 wt % to about 8.0 wt % or from about 3.0 wt % to about 7.0 wt % or from about 4.0 wt % to about 6.0 wt % or from about 4.5 wt % to about 5.5 wt % total essential oil(s) and/or essential oil component(s) based on the total dry weight of the animal feed composition.

The animal feed composition may, for example, comprise from about 0.0001 wt % to about 10 wt % total bioflavonoid(s), based on the total dry weight of the animal feed composition. The animal feed composition may, for example, comprise from about 0.1 wt % to about 10 wt % total bioflavonoid(s), based on the total dry weight of the animal feed composition. For example, the animal feed composition may comprise from about 0.001 wt % to about 10 wt % or from about 0.005 wt % to about 10 wt % or from about 0.01 wt % to about 9.5 wt % or from about 0.05 wt % to about 9 wt % or from about 0.1 wt % to about 8.5 wt % or from about 0.7 wt % to about 8 wt % or from about 0.8 wt % to about 7.5 wt % or from about 0.9 wt % to about 7 wt % or from about 1 wt % to about 6 wt % or from about 1.5 wt % to about 5.5 wt % or from about 2 wt % to about 5 wt % or from about 2.5 wt % to about 4.5 wt % or from about 3 wt % to about 4 wt % total bioflavonoid(s) based on the total dry weight of the animal feed composition. For example, the animal feed composition may comprise from about 0.2 wt % to about 10 wt % or from about 0.3 wt % to about 10 wt % or from about 0.4 wt % to about 9.5 wt % or from about 0.5 wt % to about 9 wt % or from about 0.6 wt % to about 8.5 wt % or from about 0.7 wt % to about 8 wt % or from about 0.8 wt % to about 7.5 wt % or from about 0.9 wt % to about 7 wt % or from about 1 wt % to about 6 wt % or from about 1.5 wt % to about 5.5 wt % or from about 2 wt % to about 5 wt % or from about 2.5 wt % to about 4.5 wt % or from about 3 wt % to about 4 wt % total bioflavonoid(s) based on the total dry weight of the animal feed composition.

The animal feed composition may, for example, further comprise other animal feed supplements including, for example, vitamins, minerals, antibiotics, growth stimulants and combinations thereof. For example, the animal feed composition may comprise other biologically active animal feed supplements, for example suitable for reducing methane production/emissions and/or increasing availability of nutrients to the animal. The vitamin may be any one or more of vitamin A, vitamin D, vitamin E, vitamin K, thiamine, riboflavin, pyridoxine, cyanocobalamin, carotenoids (including beta-carotene, zeaxanthin, lutein and lycopene), niacin, folic acid, pantothenic acid, biotin, vitamin C, choline, inositol, and salts and derivatives thereof. The mineral may be any one or more of calcium, phosphorous, magnesium, iron, zinc, manganese, copper, cobalt, boron, iodine, sodium, potassium, molybdenum, selenium, chromium, fluorine and chloride. The animal feed composition may, for example, comprise from about 0.001 wt % to about 5 wt % of each additional animal feed supplement or from about 0.01 wt % to about 5 wt % or from about 0.1 wt % to about 5 wt % of each additional animal feed supplement.

The animal feed composition may, for example, comprise other components in addition to the active materials such as, for example, flavourings, colourants, stabilizers (such as rosemary), enhancers (for example digestibility enhancers), buffers, emulsifiers, dispersants, thickeners, solubilising agents, micronutrients (for example selenium), antioxidants (for example vitamins such as Vitamin C, Vitamin E), feed materials (for example carbohydrates, amino acids, and urea) and the like.

Uses

The animal feed supplements and animal feed compositions described herein (including all embodiments and combinations of embodiments) may be used to reduce methane production and/or emission by animals, increase availability of nutrients to animals, and/or increase and/or increase efficiency of milk and/or meat and/or wool production by animals. Without wishing to be bound by theory, it is believed that the animal feed supplements or animal feed composition may reduce methane production by microbes in the gut of the animals, thus reducing the nutrients used by those microbes and increasing the availability of the nutrients to the animal. In particular, it is believed that the animal feed supplements or animal feed compositions improve feed digestion to increase availability of nutrients to an animal.

In certain embodiments, the animal is a ruminant animal. Ruminant animals include, for example, cows, goats, sheep, yaks, deer or antelope. In certain embodiments, the animal is a pseudo-ruminant animal. Pseudo-ruminant animals include, for example, camels and hippopotami. In certain embodiments, the animal is a monogastric animal. Monogastric animals include, for example, kangaroos, rats, dogs, pigs, cats, horses, birds (such as pigeons and penguins) and rabbits. In certain embodiments, the animal is a monogastric herbivore. Monogastric herbivores include, for example, kangaroos, horses and rabbits.

The animal feed supplements and animal feed compositions described herein may be administered orally to the animal. The animal feed supplements and animal feed compositions described herein may, for example, be administered daily to the animal.

The amount of the animal feed supplement and/or animal feed composition administered to or consumed by the animal may vary depending on the requirements of the animal and severity of methane production by the animal. The total daily amount of the animal feed supplement and/or animal feed composition administered to or consumed by the animal may, for example, be from about 10 g to about 1000 g per day or from about 100 g to about 1000 g per day or from about 200 g to about 1000 g per day or from about 300 g to about 700 g per day or from about 400 to about 500 g per day. This amount may vary depending on the requirements of the animal and severity of methane production by the animal. For example, the amount of the animal feed supplement and/or animal feed composition administered to or consumed by the animal may vary depending on the type of animal, size of animal, age of animal and/or gut microbiome of the subject. Determination of the proper amount for a particular subject is within the skill of the art. The total daily amount may be divided and administered in portions during the day if desired (e.g. two portions or three portions per day). In general, a suitable daily dose of active agents will be that amount which is the lowest dose effective to produce the desired effect. Increasing the amount of the active agents (organosulfur and essential oils and/or essential oil components) administered to/consumed by the animal may, for example, decrease the amount of methane production.

Each animal may, for example, consume up to about 10 grams of total organosulfur compound(s) and essential oil(s) and essential oil component(s) per day. For example, each animal may consume up to about 9 grams or up to about 8 grams or up to about 7 grams or up to about 6 grams or up to about 5 grams or up to about 4 grams or up to about 3 grams or up to about 2 grams of total organosulfur compounds and essential oil(s) and essential oil component(s) per day. Each animal may, for example, consume at least about 0.5 grams of total organosulfur compounds and essential oil(s) and essential oil component(s) per day. For example, each animal may consume at least about 1 gram or at least about 1.5 gram of total organosulfur compounds and essential oil(s) and essential oil component(s) per day.

The animal feed supplement described herein may, for example, reduce methane production and/or emissions by at least about 10% (compared to methane production and/or emission if the animal feed supplement was not consumed). For example, the animal feed supplement may reduce methane production and/or emissions by at least about 15% or at least about 20% or at least about 25% or at least about 30% or at least about 35% or at least about 40% or at least about 45% or at least about 50%. The animal feed supplement described herein may, for example, reduce methane production and/or emissions by up to 100%. For example, the animal feed supplement may reduce methane production and/or emissions by up to about 99% or up to about 98% or up to about 97% or up to about 96% or up to about 95% or up to about 90% or up to about 85% or up to about 80% or up to about 75% or up to about 70%. This may, for example, be measured using a micro-gas chromatograph as described in the examples below.

The animal feed supplement described herein may, for example, increase milk and/or meat and/or wool production by at least about 4% (compared to milk and/or meat and/or wool production if the animal feed supplement was not consumed). For example, the animal feed supplement may increase milk and/or meat and/or wool production by at least about 5% or at least about 10% or at least about 15% or at least about 20% or at least about 25% or at least about 30% or at least about 35% or at least about 40% or at least about 45% or at least about 50%. The animal feed supplement described herein may, for example, increase milk and/or meat and/or wool production by up to 100%. For example, the animal feed supplement may increase milk and/or meat and/or wool production by up to about 95% or up to about 90% or up to about 85% or up to about 80% or up to about 75% or up to about 70%. This may be measured, for example, by volume of milk produced per day or by weight of animal or by weight of wool.

The animal feed supplement described herein may, for example, increase efficiency of milk and/or meat and/or wool production by at least about 4% (compared to efficiency of milk and/or meat and/or wool production if the animal feed supplement was not consumed). For example, the animal feed supplement may increase efficiency of milk and/or meat and/or wool production by at least about 5% or at least about 10% or at least about 15% or at least about 20% or at least about 25% or at least about 30% or at least about 35% or at least about 40% or at least about 45% or at least about 50%. The animal feed supplement described herein may, for example, increase efficiency of milk and/or meat and/or wool production by up to 100%. For example, the animal feed supplement may increase efficiency of milk and/or meat and/or wool production by up to about 95% or up to about 90% or up to about 85% or up to about 80% or up to about 75% or up to about 70%. Efficiency relates to the degree to which a particular biological process (e.g. milk, meat, wool production) takes place per unit of nutrition consumed. This may be measured, for example, by change in volume of milk produced per day or weight of animal or weight of wool divided by the total nutrients consumed by the animal.

The animal feed supplement described herein may, for example, increase nutrient availability by at least about 5% (compared to milk and/or meat and/or wool production if the animal feed supplement was not consumed). For example, the animal feed supplement may increase nutrient availability by at least about 10% or at least about 15% or at least about 20% or at least about 25% or at least about 30% or at least about 35% or at least about 40% or at least about 45% or at least about 50%. The animal feed supplement described herein may, for example, increase nutrient availability by up to 100%. For example, the animal feed supplement may increase nutrient availability by up to about 95% or up to about 90% or up to about 85% or up to about 80% or up to about 75% or up to about 70%. Nutrient availability refers to the amounts of nutrients that are available to the animal to be used for biological/metabolic functions.

In certain embodiments, the organosulfur compound(s) (e.g. allicin) and essential oil(s) and/or essential oil component(s) present in the animal feed supplement or composition may act synergistically to reduce methane production, increase nutrient availability and/or increase meat and/or milk and/or wool production. The synergistic combination of organosulfur compound(s) (e.g. allicin) and essential oil(s) and/or essential oil component(s) delivers an effect that is greater than the sum of the effect by the individual organosulfur compound(s) and essential oil(s) and/or essential oil component(s) on their own and thus can provide an improved performance.

Methods of Manufacture

The animal feed supplements described herein may be made by combining one or more organosulfur compound(s) and one or more essential oil(s) and/or one or more essential oil component(s). The animal feed compositions described herein may be made by combining an animal feed with one or more essential oil(s) and/or one or more essential oil component(s). The components are combined in suitable amounts to obtain a composition having the desired quantity and/or concentration of each component. Each component may be combined with one or more other components in any order and combination suitable to obtain the desired product. For example, each component may be combined by mixing or blending. For example, the one or more organosulfur compound(s) and one or more essential oil(s) and/or one or more essential oil component(s) may be combined with an animal feed by placing the one or more organosulfur compound(s) and one or more essential oil(s) and/or one or more essential oil component(s) on top of the animal feed (top-dressing). Such methods are well known in the art. The composition may be prepared in the dry solid form, for example, powder form, and subject to further processing step depending on the types of the formulation for the intended finished products. The methods may further comprise a forming step, wherein the mixture is moulded, pressed, spray dried or otherwise formed into a shape (e.g. bar, ball, pellet, clusters, tablet), preferably with dimensions and/or textures suitable for consumption by an animal of the types described herein. The methods may comprise housing the animal feed or animal feed supplement in a specific delivery device such as a syringe. The method may comprise forming animal feed supplement or animal feed into a bolus tablet that may be intended to stay in the stomach of the animal (e.g. rumen of the ruminant animal).

The animal feed supplements described herein may be packaged in a protective packaging material, such as Flexible Intermediate Bulk Container (FIBC), woven bags, paper bags, aluminium bags or polyethylene bags. In certain embodiments, the animal feed supplements are packaged in a watertight and/or an airtight material in a box or vacuum-packed. In some embodiments, the animal feed supplements are packed under nitrogen to prevent degradation by oxygen.

The following numbered paragraphs define particular embodiments of the present invention:
1. An animal feed supplement comprising:
   at least one organosulfur compound; and
   at least one essential oil and/or at least one component of an essential oil.
2. The animal feed supplement of paragraph 1, wherein at least one organosulfur compound is selected from allicin, ajoene, alliin, allylpropyl disulfide, diallyl trisulfide, s-allylcysteine, vinyldithiines (e.g. 3-vinyl-4H-1,2-dithiin and 2-vinyl-4H-1,3-dithiin), diallyl disulphide, and combinations of two or more thereof.
3. The animal feed supplement of paragraph 1 or 2, wherein at least one organosulfur compound is allicin.
4. The animal feed supplement of any preceding paragraph, wherein at least one organosulfur compound is from a plant of the Allium genus, for example Allium sativum (garlic).
5. The animal feed supplement of any preceding paragraph, wherein at least one essential oil is selected from coriander oil, nutmeg oil, wild carrot oil, pine oil, clove oil, and combinations of two or more thereof and/or wherein at least one component of an essential oil is selected from at least one component of coriander oil, at least one component of nutmeg oil, at least one component of wild carrot oil, at least one component of pine oil, at least one component of clove oil, and combinations of two or more components of one or more of coriander oil, nutmeg oil, wild carrot oil, pine oil, and clove oil.
6. The animal feed supplement of any preceding paragraph, wherein at least one essential oil is coriander oil and/or wherein at least one component of an essential oil is at least one component of coriander oil.
7. The animal feed supplement of any preceding paragraph, wherein at least one essential oil comprises bornyl acetate, geranyl acetate, eugenol, linalool, geraniol, neryl acetate, or a combination of two or more thereof.
8. The animal feed supplement of any preceding paragraph, wherein at least one component of an essential oil is selected from bornyl acetate, geranyl acetate, eugenol, linalool, geraniol, neryl acetate, and combinations or two or more thereof.
9. The animal feed supplement of any preceding paragraph, further comprising at least one bioflavonoid.
10. The animal feed supplement of paragraph 9, wherein at least one bioflavonoid is selected from naringin, neohesperidin, eriocitrin, isonaringin, naringinin, hesperidin, roifolin, diosmin, didymin, hesperetin, poncirin, and combinations of two or more thereof.
11. The animal feed supplement of paragraph 9 or 10, wherein at least one bioflavonoid is selected from naringin, neohesperidin, and a combination thereof.
12. The animal feed supplement of any preceding paragraph, wherein the weight ratio of total organosulfur compounds to total essential oils and essential oil components in the animal feed supplement ranges from about 10:1 to about 1:400, for example from about 10:1 to about 1:200 or from about 1:1 to about 1:150 or from about 1:1 to about 1:50.
13. The animal feed supplement of any preceding paragraph, wherein the animal feed supplement comprises equal to or greater than about 0.0001 wt % and/or equal to or less than about 20.0 wt % total organosulfur compounds.
14. The animal feed supplement of any preceding paragraph, wherein the animal feed supplement comprises equal to or greater than about 0.0001 wt % and/or equal to or less than about 20.0 wt % total essential oils and essential oil components.
15. An animal feed composition comprising an animal feed supplement according to any preceding paragraph.
16. The animal feed composition of paragraph 15, wherein the animal feed composition comprises from about 0.0001 wt % to about 10 wt % of total organosulfur compounds based on the dry weight of the animal feed composition.
17. The animal feed composition of paragraph 14 or 15, wherein the animal feed composition comprises from about 0.0001 wt % to about 10 wt % of total essential oils and essential oil components based on the dry weight of the animal feed composition.
18. Use of an animal feed supplement or an animal feed composition of any preceding paragraph to reduce methane production by an animal.
19. Use of an animal feed supplement or an animal feed composition of any preceding paragraph to increase and/or increase efficiency of milk and/or meat and/or wool production by an animal.
20. Use of an animal feed supplement or an animal feed composition of any preceding paragraph to increase availability of nutrients to an animal.
21. The use of any of paragraphs 18 to 20, wherein the animal feed supplement or animal feed composition is consumed by the animal.
22. The use of any of paragraphs 18 to 21, wherein the total daily amount of animal feed supplement and/or animal feed composition consumed by the animal is from about 10 g to about 1000 g.
23. The use of any of paragraphs 18 to 22, wherein the animal consumes up to about 10 g of total organosulfur and essential oils per day.
24. The use of any of paragraphs 18 to 23, wherein the animal is a ruminant animal such as a cow, goat, or sheep.
25. A method of making an animal feed supplement of any of paragraphs 1 to 14, the method comprising combining at least one organosulfur compound and at least one essential oil and/or at least one component of an essential oil.
26. A method of making an animal feed composition of any of paragraphs 15 to 17, the method comprising combining an animal feed composition with at least one organosulfur compound and at least one essential oil and/or at least one component of an essential oil.

The invention will now be described in detail by way of reference only to the following non-limiting examples.

### EXAMPLES

### Example 1

Method

The individual and combined effects of the following test materials was determined.
Garlic Powder—containing a standardised amount (1.1%) of allicin;
Eugenol;
Geranyl acetate;
Coriander oil.

The garlic powder used in example 1 was commercially available. The essential oils and the components of the essential oils were obtained from Sigma-Aldrich. The CAS numbers of the other materials are as follows: Eugenol—CAS number 97-53-0, Geranyl acetate—CAS number 105-87-3; and Coriander oil—CAS number 8008-52-4.

Rumen inoculum was obtained before the morning feeding from 3 rumen fistulated dairy cows on a diet composed of 50% maize silage and 50% wilted grass silage (on dry matter basis) supplemented with some straw and urea. Additionally, soybean meal and balanced compound feed were administered to fulfil the animals' requirements for milk production.

Test materials were incubated in 125-mL flasks containing 25 mL of CO₂-saturated bicarbonate/phosphate buffer (containing 3.58 g Na₂HPO₄.12H₂O, 1.55 g KH₂PO₄, 0.124 g MgCl₂.6H₂O, 8.74 g NaHCO₃ and 1.71 g NH₄HCO₃ per liter of distilled water) and rumen inoculum, in triplicate per test material (3 biological replicates). A mixture of maize silage (crude protein 65.6 g kg⁻¹, crude fat 27.9 g kg⁻¹, crude fibre 145 g kg⁻¹ and starch 410 g kg DM⁻¹), grass silage (crude protein 153 g kg⁻¹, crude fat 28.8 g kg⁻¹, crude fibre 277 g kg⁻¹ and sugar 78.5 g kg⁻¹) and dairy concentrate (crude protein 183 g kg⁻¹, crude fibre 29 g kg⁻¹ an sugar 89 g kg⁻¹) was used as the substrate (30/30/40, DM weight basis, 250 mg flask⁻¹).

The test materials (garlic powder, eugenol, geranyl acetate and coriander oil) were added shortly before the incubation directly into the fluid. All flasks were incubated in a shaking incubator at 39° C. (Edmund Buhler Gmbh, Hechingen, Germany). At the end of the 24 hour incubation, flasks were removed from the incubator and placed in ice water to stop the fermentation. pH, gas pressure and gas composition were measured, and samples were collected for VFA analysis.

Different amounts of garlic powder were used providing allicin doses of 0.1 mg, 0.2 mg, 0.4 mg, and 0.8 mg per flask (i.e. 4 mg/l, 8 mg/l, 16 mg/l, and 32 mg/l). A fixed concentration of 500 mg/l (i.e. 12.5 mg/flask) for the other test materials was used. Water was used as a negative control.

The amount of methane gas was measured using a micro-gas chromatograph equipped with two gas chromatographic modules and a thermal conductivity detector (3000 micro-GC, Agilent, USA). Ethane (C₂H₆; 1 mL/flask) was used as internal standard and argon as a carrier gas for both columns.

The data obtained with the test materials was normalized to a non-treated control group, i.e. samples receiving the substrate only (negative control). I.e. 100% refers to the value of the negative control. Values below 100% indicate reduction of methane as a result of the additive. Values above 100% indicate an increase in methane production.

The synergism between garlic and a component of essential oil was also studied. Synergy was calculated by adding the percentage reduction of methane by garlic alone and eugenol or geranyl acetate alone and then subtracting the percentage reduction of the combination and the component of essential oil. The resulting values were inversed. Positive values show synergistic effect and the negative values indicate inhibitory effects. The higher the positive value, the better the synergistic effects.

The results are shown in FIGS. 1 to 5.

FIG. 1 shows that the addition of eugenol to garlic provides a better effect than the individual compounds, particularly when combining 0.4 mg and 0.8 mg of allicin per flask with eugenol.

FIG. 2 shows that the combination of garlic and coriander oil provides a better effect than the individual compounds, particularly when combining 0.8 mg of allicin per flask with coriander oil.

FIG. 3 shows that the addition of geranyl acetate to garlic provides a better effect than the individual compounds, particularly when combining 0.4 mg and 0.8 mg of allicin per flask with geranyl acetate.

FIG. 4 shows that the emission of methane is reduced by the combination of garlic and essential oil or essential oil components compared to garlic alone. The effect from garlic is dose dependent.

The result for synergistic effects is shown in FIG. 5. It is apparent that the addition of eugenol or geranyl acetate to garlic shows synergistic effect, with eugenol showing better synergistic effect than geranyl acetate when combined with garlic.

### Example 2

An experiment was conducted to test the dose-dependent effects of the essential oils and the components of the essential oils. The same method and test materials of Example 1 was used in this experiment.

Different amounts of garlic powder were used providing allicin doses of 0.1 mg, 0.2 mg, 0.4 mg, and 0.8 mg per flask (i.e. 4 mg/l, 8 mg/l, 16 mg/l, and 32 mg/l). The doses of eugenol, geranyl acetate, coriander oil and bornyl acetate were varied in this experiment whereby 0.25 mg/ml, 0.5 mg/ml, 0.75 mg/ml of test materials was used. Water was used as a negative control.

The amount of methane produced for each reaction was measured using the same method as described in Example 1.

Table 1 shows the dose response of garlic and eugenol on production of methane (μmol/reaction).

TABLE 1

| Garlic | |
|---|---|
| (Allicin | Eugenol (mg/mL) |

| mg/flask) | 0 | 0.25 | 0.5 | 0.75 |
|---|---|---|---|---|
| 0 | 404 | 388 | 310 | 234 |
| 0.1 | 407 | 363 | 284 | 243 |
| 0.2 | 386 | 340 | 260 | 232 |
| 0.4 | 333 | 267 | 172 | 98 |
| 0.8 | 113 | 83 | 14 | 2 |

Table 2 shows the dose response of garlic and coriander oil on production of methane (μmol/reaction).

TABLE 2

| Garlic | |
|---|---|
| (Allicin | Coriander oil (mg/mL) |

| mg/flask) | 0 | 0.25 | 0.5 | 0.75 |
|---|---|---|---|---|
| 0 | 404 | 375 | 278 | 257 |
| 0.1 | 407 | 364 | 282 | 263 |
| 0.2 | 386 | 351 | 279 | 266 |
| 0.4 | 333 | 313 | 242 | 248 |
| 0.8 | 113 | 128 | 28 | 7 |

Table 3 shows the dose response of garlic and geranyl acetate on production of methane (μmol/reaction).

TABLE 3

| Garlic | |
|---|---|
| (Allicin | Geranyl acetate (mg/mL) |

| mg/flask) | 0 | 0.25 | 0.5 | 0.75 |
|---|---|---|---|---|
| 0 | 457 | 436 | 327 | 203 |
| 0.1 | 463 | 426 | 298 | 187 |
| 0.2 | 438 | 394 | 260 | 75 |
| 0.4 | 367 | 230 | 55 | 11 |
| 0.8 | 109 | 22 | 7 | 0 |

Table 4 shows the dose response of garlic and bornyl acetate on production of methane (μmol/reaction).

TABLE 4

| Garlic | |
|---|---|
| (Allicin | Bornyl acetate (mg/mL) |

| mg/flask) | 0 | 0.25 | 0.5 | 0.75 |
|---|---|---|---|---|
| 0 | 457 | 422 | 353 | 267 |
| 0.1 | 463 | 424 | 343 | 242 |
| 0.2 | 438 | 405 | 336 | 234 |
| 0.4 | 367 | 351 | 295 | 207 |
| 0.8 | 109 | 136 | 68 | 47 |

The data shown in Tables 1-4 are represented in graph form in FIGS. 6-9.

All the figures show that the methane production decreases at increased doses of the essential oils or components of essential oils. More specifically, at lower concentrations of allicin i.e. 0.1, 0.2 and 0.4 mg/flask, the methane reduction effect of essential oils or components of essential oils is clearly observed whereby the methane productions are reduced at greater levels by the combination compared to methane reduction observed with garlic alone.

1. An animal feed supplement comprising:
at least one organosulfur compound; and
at least one essential oil and/or at least one component of an essential oil.

2. The animal feed supplement of claim 1, wherein the at least one organosulfur compound is selected from allicin, ajoene, alliin, allylpropyl disulfide, diallyl trisulfide, s-allyleysteine, vinyldithiines, diallyl disulphide, and combinations of two or more thereof.

3. The animal feed supplement of claim 1, wherein the at least one organosulfur compound is from a plant of the Allium genus.

4. The animal feed supplement of claim 1, wherein the at least one essential oil is selected from coriander oil, nutmeg oil, wild carrot oil, pine oil, clove oil, and combinations of two or more thereof; and/or wherein the at least one component of an essential oil is selected from at least one component of coriander oil, at least one component of nutmeg oil, at least one component of wild carrot oil, at least one component of pine oil, at least one component of clove oil, and combinations of two or more components of one or more of coriander oil, nutmeg oil, wild carrot oil, pine oil, and clove oil.

5. The animal feed supplement of claim 1, wherein the at least one essential oil comprises bornyl acetate, geranyl acetate, eugenol, linalool, geraniol, neryl acetate, or a combination of two or more thereof, and/or wherein the at least one component of an essential oil is selected from bornyl acetate, geranyl acetate, eugenol, linalool, geraniol, neryl acetate, and combinations or two or more thereof.

6. The animal feed supplement of claim 1, further comprising at least one bioflavonoid optionally selected from naringin, neohesperidin, eriocitrin, isonaringin, naringinin, hesperidin, roifolin, diosmin, didymin, hesperetin, poncirin, and combinations of two or more thereof.

7. The animal feed supplement of claim 1, wherein the weight ratio of total organosulfur compounds to total essential oils and essential oil components in the animal feed supplement ranges from about 10:1 to about 1:400.

8. The animal feed supplement of claim 1, wherein the animal feed supplement comprises equal to or greater than about 0.0001 wt % and/or equal to or less than about 20.0 wt % total organosulfur compounds, and/or equal to or greater than about 0.0001 wt % and/or equal to or less than about 20.0 wt % total essential oils and essential oil components.

9. An animal feed composition comprising the animal feed supplement according to claim 1.

10. The animal feed composition of claim 9, wherein the animal feed composition comprises from about 0.0001 wt % to about 10 wt % of total organosulfur compounds, and/or from about 0.0001 wt % to about 10 wt % of total essential oils and essential oil components, based on a dry weight of the animal feed composition.

11. Use of the animal feed supplement of claim 1 to:
reduce methane production by an animal; and/or
increase and/or increase efficiency of milk and/or meat and/or wool production by an animal; and/or
increase availability of nutrients to an animal.

12. The use of claim 11, wherein the animal feed supplement is consumed by the animal.

13. The use of claim 12, wherein the animal is a ruminant animal selected from a cow, goat, or sheep.

14. A method of making the animal feed supplement of claim 1, the method comprising combining the at least one organosulfur compound and the at least one essential oil and/or the at least one component of an essential oil.

15. A method of making the animal feed composition of claim 9, the method comprising combining an animal feed and the animal feed supplement with the at least one organosulfur compound and the at least one essential oil and/or the at least one component of an essential oil.

16. The animal feed supplement of claim 1, wherein the at least one organosulfur compound comprises 3-vinyl-4H-1,2-dithiin and 2-vinyl-4H-1,3-dithiin.

17. The animal feed supplement of claim 1, wherein the at least one organosulfur compound is from an Allium sativum plant.

18. The animal feed supplement of claim 1, further comprising a combination of allicin, eugenol, geranyl acetate, and coriander oil.

19. A method of using the animal feed supplement of claim 1, comprising:
feeding the animal feed supplement to an animal to: reduce methane production by the animal; and/or increase and/or increase efficiency of milk and/or meat and/or wool production by the animal; and/or increase availability of nutrients to the animal.

20. The method of claim 19, wherein the animal is a ruminant animal.
